(19) United States
(12) Patent Application Publication
(10) Pub. No.: US 2020/0351991 A1
(43) Pub. Date: Nov. 5, 2020

(54) MONITORING INDUCTION COIL PHASE AND CURRENT IN INDUCTION HEATING SYSTEMS

(71) Applicant: Haier US Appliance Solutions, Inc., Wilmington, DE (US)

(72) Inventor: Isaac Nam, Louisville, KY (US)

(21) Appl. No.: 16/402,477

(22) Filed: May 3, 2019

(51) Int. Cl. H05B 6/06; H05B 6/12

(52) U.S. Cl. CPC H05B 6/062; H05B 6/1209

(57) ABSTRACT

Induction heating systems operational methods are provided herein. An induction heating system can include an induction heating coil operable to inductively heat a load with a magnetic field, a variable frequency inverter module supplying an alternating current to the induction heating coil, a current sensor for detecting a current through the induction heating coil and providing a current signal representative of said current, and a controller for controlling the frequency of the current to the induction heating coil and to condition the current signal to create a conditioned current signal. The controller is configured to determine a presence of a load on the induction heating coil and control a frequency of the current to the induction heating coil based on a comparison of the conditioned current signal to a pulse-width modulated waveform.

### FIELD OF THE INVENTION

The present subject matter relates generally to induction heating systems used, for instance, in cooktop appliances, and more particularly to monitoring induction coil phase and current in induction heating systems and apparatuses.

### BACKGROUND OF THE INVENTION

Induction cook-tops heat conductive cookware by magnetic induction. An induction cook-top applies radio frequency current to a heating coil to generate a strong radio frequency magnetic field on the heating coil. When a conductive vessel, such as a pan, is placed over the heating coil, the magnetic field coupling from the heating coil generates eddy currents on the vessel. This causes the vessel to heat.

An induction cook-top will generally heat any vessel of suitable conductive material of any size that is placed on the induction cook-top. Since the magnetic field is not visible, unless some secondary indicator is provided, it is not readily apparent whether the induction cook-top is powered (on) or off. Thus, it is possible for items placed, on the induction cook-top to be heated unintentionally, which could damage such items and create other problems.

There are multiple methods of vessel or pan detection on an induction cook-top. Some of these include mechanical switching, current detection, phase detection, optical sensing and harmonic distortion sensing. In pan sensing methods that utilize phase detection and amplitude measurements, a current transformer can be used. When the system is operating at resonance, the optimal power transfer between the heating coil and the vessel will occur. However, resonance is dependent upon the load presented by the vessel. Therefore, it may be desirable to be able to determine the resonant frequency of the system for the particular load; and to operate at or near the resonant frequency of a particular load.

As a result, further improvements in detecting loads and frequencies may be desirable. In particular, it would be advantageous to provide an induction heating system with current and phase monitoring.

### BRIEF DESCRIPTION OF THE INVENTION

Aspects and advantages of the invention will be set forth in part in the following description, or may be obvious from the description, or may be learned through practice of the invention.

In one example aspect of the present disclosure, an induction heating system is provided. The induction heating system can include an induction heating coil operable to inductively heat a load with a magnetic field, a variable frequency inverter module supplying an alternating current to the induction heating coil, a current sensor for detecting a current through the induction heating coil and providing a current signal representative of said current, and a controller for controlling the frequency of the current to the induction heating coil and to condition the current signal to create a conditioned current signal. The controller is configured to determine a presence of a load on the induction heating coil and control a frequency of the current to the induction heating coil based on a comparison of the conditioned current signal to a pulse-width modulated waveform.

According to another example aspect of the present disclosure, another induction heating system is provided. The induction heating system can include an induction heating coil operable to inductively heat a load with a magnetic field, a variable frequency inverter module supplying an alternating current to the induction heating coil, a current transformer in series with the induction heating coil and providing a current signal representative of a current flowing through the induction heating coil, and a controller for controlling the frequency of the current to the induction heating coil and to condition the current signal to create a conditioned current signal. The controller can be further configured to determine a presence of a load on the induction heating coil and control a frequency of the current to the induction heating coil.

According to yet another example aspect of the present disclosure, another induction heating system is provided. The induction heating system can include an induction heating coil operable to inductively heat a load with a magnetic field, a variable frequency inverter module supplying an alternating current to the induction heating coil, a current shunt monitor effectively in parallel with the induction heating coil and providing a current signal representative of a scaled current flowing through the induction heating coil, and a controller for controlling the frequency of the current to the induction heating coil and to condition the current signal to create a conditioned current signal. The controller can be further configured to determine a presence of a load on the induction heating coil and control a frequency of the current to the induction heating coil.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 shows a schematic block diagram of an induction heating system, according to example embodiments of the present disclosure.

FIG. 2 is a schematic of an implementation of the inverter module and current sensor of the induction heating system of FIG. 1.

FIG. 3 is a schematic of an additional implementation of the inverter module and current sensor of the induction heating system of FIG. 1.

FIG. 4 is a graph of operational waveforms of the inverter module of FIG. 2 or FIG. 3.

FIG. 5 is a graph of scaled output of a portion of the operational waveforms of FIG. 2 or FIG. 3 using an example of inverted low-side PWM, which effectively represents non-inverted high-side PWM without dead-time.

FIG. 6 is a graph of a comparison between a portion of the operational waveforms of FIG. 2 or FIG. 3.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). Furthermore, as used herein, terms of approximation, such as “approximately” or “substantially,” refer to being within a ten percent margin of error.

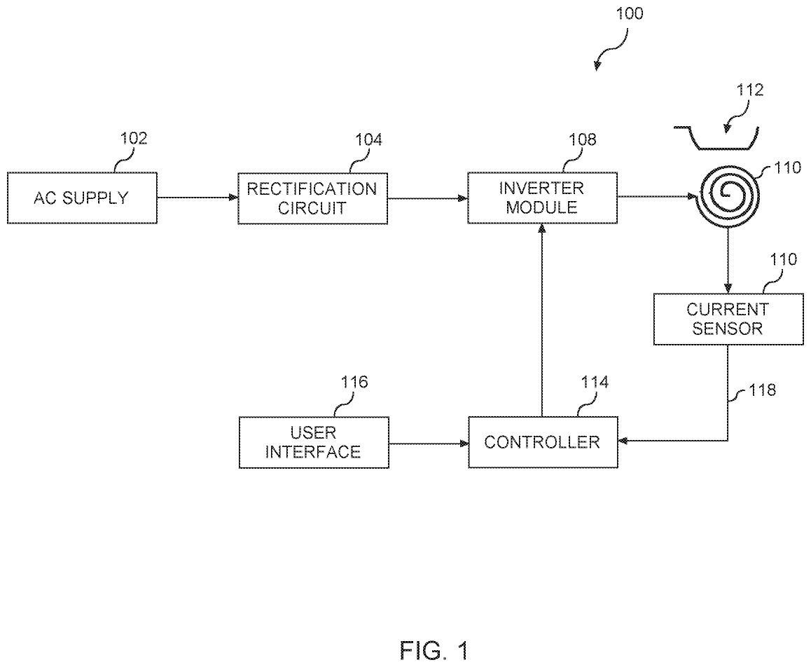

FIG. 1 is a schematic block diagram of an induction heating system 100 according to one embodiment of the present disclosure. In operation, the system 100 can be configured to detect a presence of a vessel 112 on an induction heating coil 110 and control the power supplied to the induction heating coil 110 at a power level selected by a user from a range of user selectable power settings, where the power supplied is based on size and type of vessel detected and selected power setting.

As shown schematically in FIG. 1, the induction heating system 100 generally includes AC supply 102, which may provide conventional 60 Hz 120 or 240 volt AC supplied by utility companies, and a conventional rectifier circuit 104 for rectifying the power signal from AC supply 102. Rectifier circuit 104 may include filter and power factor correction circuitry to filter the rectified voltage signal. The induction heating system 100 also includes an inverter module 108 for supplying an alternating current to the induction heating coil 110. Accordingly, the inverter module 108 may also be termed a variable frequency inverter module. The induction heating coil 110, when supplied by the inverter module 108 with an alternating current, inductively heats the cooking vessel 112 or other object placed on, over, or near the induction heating coil 110. It will be understood that use of the term “cooking vessel” herein is merely exemplary, and that term will generally include any object of a suitable type that is capable of being heated by an induction heating coil.

The frequency of the current supplied to the induction heating coil 110 by inverter module 108 and hence the output power of the induction heating coil 110 is controlled by controller 114 which controls the switching frequency of the inverter module 108. The controller 114 may also be implemented as a microcontroller and/or gate driver to drive individual transistors or switching devices of the system 100 with pulse-width modulated signals.

A user interface 116 allows a user to establish the power output of the induction heating coil 110 by selecting a power setting from a plurality of user selectable settings. The user interface 116 is operatively connected to controller 114. A current sensor 117 senses the current supplied to the induction heating coil 110 by the inverter circuit 108 and provides a current signal 118 to controller 114. The current sensor signal 118 is a signal that is representative of the current flowing through the induction heating coil 110 derived from one of a plurality of possible devices. For example, the current sensor 117 may include a current transformer, a current shunt monitor, a Hall-Effect sensor, or any suitable current sensing device.

Controller 114 uses the inputs from the user interface 116 and the current sensor signal 118 from current sensor 117 to control energization of the induction heating coil 110. For example, the controller 114 can use the current sensor signal 118 to sense or detect the presence of the vessel 112 on the induction heating coil 110, determine a size and type of vessel, and determine the resonant frequency of the system 100 when heating the detected vessel and determine the appropriate switching frequency to achieve the output power corresponding to the user selected power setting.

According to one example, the controller 114 is operative to control the frequency of a power signal generated by inverter module 108 to operate the induction heating coil 110 at the power level corresponding to the setting selected by the user via user interface 116. The controller 114 monitors the current sensor signal 118 and processes the current sensor signal 118 to determine, the presence of the cooking vessel 112 on the induction heating coil 110 as well as a size and type of the vessel 112 and the resonant frequency of the power circuit with the vessel present. Based on the determined size and type of vessel, or lack thereof, the controller 114 is configured to control power to the induction heating coil 110, which can include turning the power off.

The current sensor signal 118 is sampled repetitively during each full switching cycle. The collection of sampled values of current sensor signal 118 over a switching cycle comprises a current signature, which is captured and analyzed by the controller 114 to determine phase and current through the induction heating coil 110.

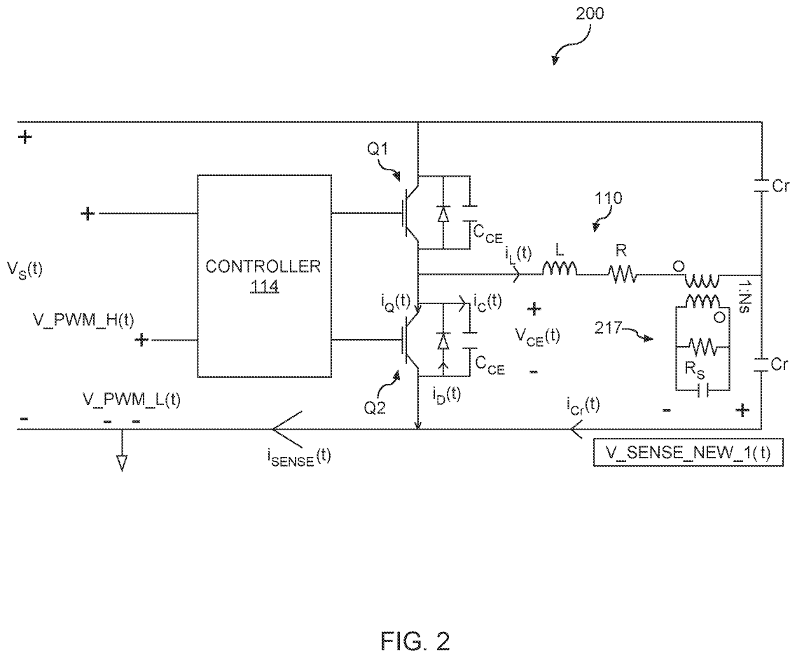

FIG. 2 is a schematic of an implementation of the inverter module and current sensor of the induction heating system of FIG. 1. As shown in FIG. 2 the induction heating system 200 includes a current transformer 201 arranged to sense current in the induction heating coil 110. As also shown, inverter module 108 is represented as a half-bridge series resonant converter circuit comprising switching devices Q1 and Q2, and capacitors C_{CE} and C_{R}, which provide alternating current power signal to the induction coil 110 by the controlled switching of the direct voltage provided from the rectification circuit 104. The controller 114 controls the switching of Q1 and Q2 using one or more pulse-width modulated signals. In one embodiment, the switching devices Q1 and Q2 are Insulated-Gate Bipolar Transistors (“IGBT”). In alternate embodiments, any suitable switching devices can be used, including Metal-Oxide Semiconductor Field Effect Transistors and/or any other suitable devices. Snubber capacitors C_{CE} and resonant capacitors C_{R} are connected between a positive power terminal and a negative power terminal to successively resonate with the induction heating coil 110.

The induction heating coil 110 is connected between the switching devices Q1, Q2 and induces an eddy current in a vessel 112 located on or near the induction heating coil 110. The eddy current heats the vessel 112.

In one embodiment, this switching of switching devices Q1 and Q2 occurs at a switching frequency in a range between approximately 20 kilohertz to 50 kilohertz. When switching device Q1 is turned on, and switching device Q2 is turned off, the resonance capacitor C_{R}, the induction heating coil 110 and a pan 112 form a resonant circuit. When the switching device Q1 is turned off, and switching device Q2 is turned on, the resonant capacitor C_{R}, the induction heating coil 110, and the pan 112, form a resonant circuit. Current transformer 217 provides a sensor signal 118 to controller 114.

By examining the current sensor signal 118, the induction heating system 200 can identify the presence, or lack thereof, of a vessel 112 over the induction heating coil 110. Also, operating near the resonant frequency provides high power from the induction coil 110 to the vessel 112 shown in FIG. 1. Analysis of signal 118 as a function of switching frequency can also be used to detect the resonant frequency of the system with a vessel in position for heating.

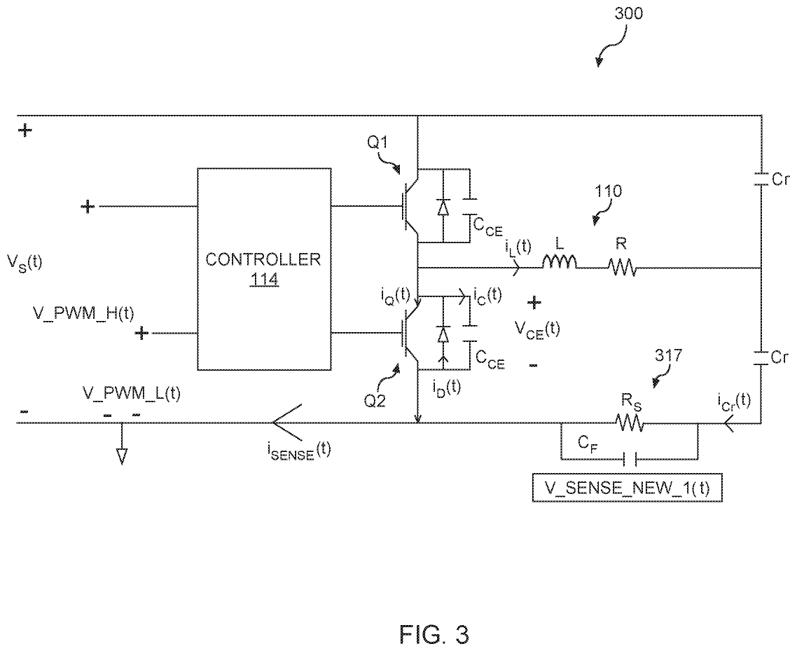

As described briefly above, the system 100 may also use a variety of current sensing circuitry to facilitate vessel detection, frequency detection, and phase detection. FIG. 3 is a schematic of an additional implementation of the inverter module and current sensor of the induction heating system of FIG. 1. As shown in FIG. 3, the system 300 may include a current shunt monitor 317 rather than the current transformer 217. The current shunt monitor 317 may provide a signal 118 based on a current flowing in the induction heating coil 110.

Similar to the implementation shown in FIG. 2, by examining the current sensor signal 118, the induction heating system 300 can identify the presence, or lack thereof of a vessel 112 over the induction cooking coil 110. Also, operating at the resonant frequency aids in transferring the optimal amount of power from the induction coil 110 to the vessel 112 shown in FIG. 1. Analysis of signal 118 as a function of switching frequency can also be used to detect the resonant frequency of the system with a vessel in position for heating.

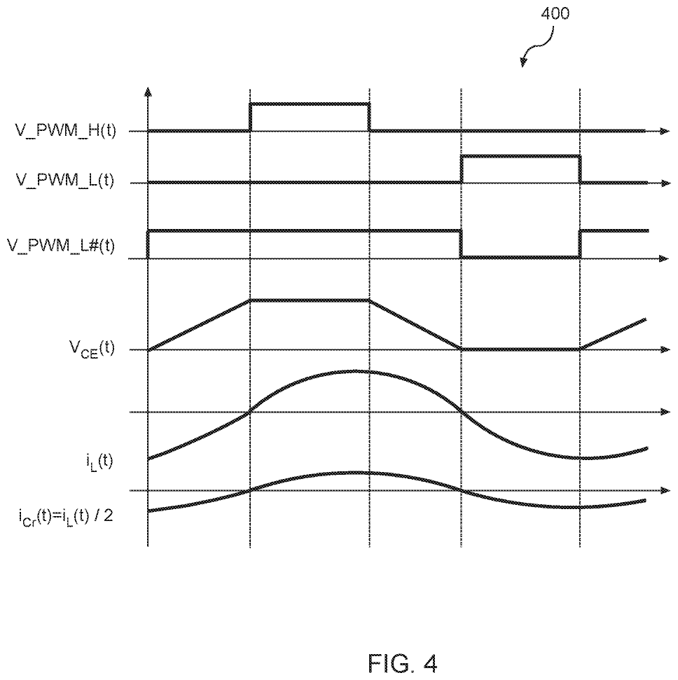

Hereinafter, operational waveforms of the system 100 are described in detail. FIG. 4 is a graph of optimal waveforms of the induction heating system of FIG. 1 operating near a resonant frequency. A PWM signal V_PWM_H(t) represents turn-on and turn-off commands for high-side switching device Q1. A PWM signal V_PWM_L(t) represents turn-on and turn-off commands for low-side switching device Q2. The inverted version of V_PWM_L(t) is denoted as V_PWM_L #(t), and its rising edge and falling edge correspond respectively to rising and falling edge of voltage VCE(t) across low-side switching device Q2. Initially, it is noted that for the purposes of discussion, current sense signal 118 is represented by either induction heating coil current i_{L}(t) or resonant capacitor current i_{CR}(t). Generally, the relationship between the two currents can be designated as i_{CR}(t)≈i_{L}(t)/2. Furthermore, i_{L}(t) and i_{CR}(t) are always continuous when the inverter module 108 is operating. Additionally, i_{L}(t) and i_{CR}(t) have relatively diminished derivative magnitudes as compared to traditional current sensing signals such as those from low-side IGBT's current and/or inverter's return input current. Finally, the induction heating coil 110 (with associated resistance R) and resonant capacitors C_{R} form a resonant tank that can serve as a band-pass filter. Therefore, i_{L}(t) and i_{CR}(t) have much less harmonic distortions as compared to inverter's return input current i_{SENSE}(t), thereby allowing for much improved accuracy and precision in estimating load current levels and phase shift conditions with reduced sensitivity against parasitic inductances existing on the inverter board.

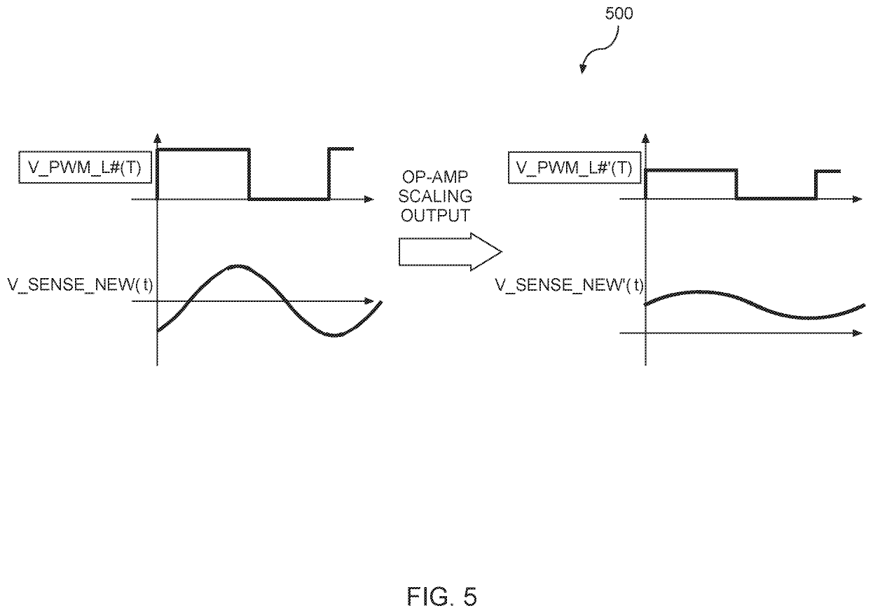

Referring now to FIG. 2, FIG. 3, and FIG. 4, any of the two sensed voltage signals including V_SENSE_NEW_1(t) from a current measurement of i_{L}(t) and V_SENSE_NEW_1(t) from a current measurement of i_{CR}(t) measurement can provide a straightforward estimation of coil current i_{L}(t). As further shown, the controller 114 can output at least two pulse-width modulated waveforms V_PWM_H(t) and V_PWM_L(t). Generally, feedback circuits such as those using a sensing resistor and an operational amplifier, or other portions of the controller 114, may condition the current signal(s) i_{L}(t) and i_{CR}(t) to create conditioned current signal(s) V_SENSE_NEW′(t). The controller 114 is further configured to determine a presence of the load 112 on the induction heating coil 110 and control a frequency of the current to the induction heating with V_PWM_H(t) and V_PWM_L(t). A conditioned current signal V_SENSE_NEW′(t) is represented by V_SENSE_NEW(t) in FIG. 5.

FIG. 5 is a graph of scaled output of a portion of the operational waveforms of FIG. 4. As shown in FIG. 5, an operational amplifier or other signal conditioning portion of the controller 114 may be used to scale V_SENSE_NEW (t) to V_SENSE_NEW′(t). It is noted that this conditioning and scaling may be optional in some implementations.

Thereafter, or at significantly the same time, V_PWM_L #(t) can also be scaled such that its amplitude and DC offset can be reduced to desired levels to obtain V_PWM_L #′(t).

By measuring V_SENSE_NEW′(t) with the controller 114, coil current (i_{L}(t)) can be estimated by taking into account a transfer function of the controller 114's signal conditioning stage that can include an op-amp circuit transfer function, turns ratio of the current transformer 217, sense resistor's resistance, hall-effect sensor scale factor, and/or shunt monitor circuit 317 transfer function.

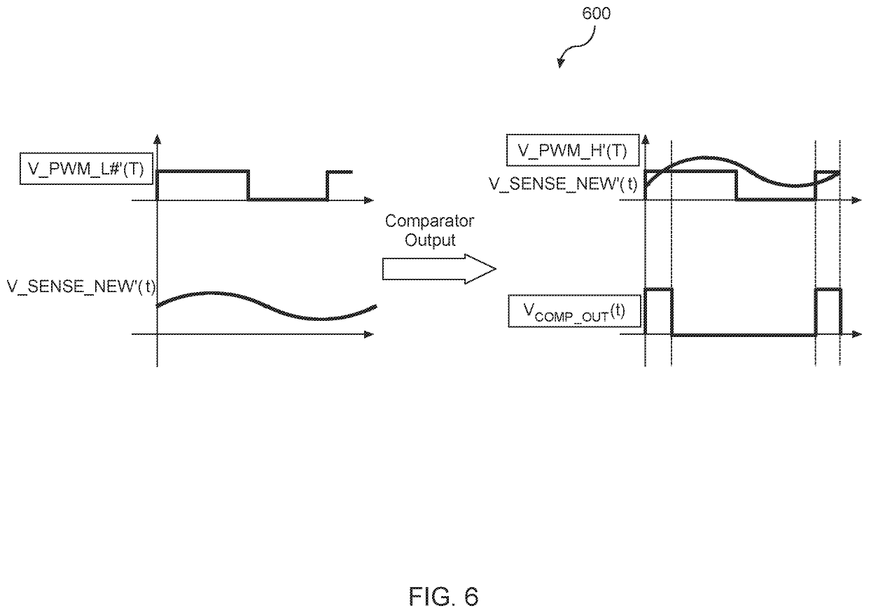

FIG. 6 is a graph of a comparison between a portion of the operational waveforms of FIG. 4. As shown, V_PWM_H′(t) and V_SENSE_NEW′(t) can be compared in a comparator circuit. It should be noted that V_PWM_L #′(t) can be used instead of V_PWM_H′(t). The comparator's output (VCOMP_OUT(t)) is a voltage pulse train. Based on pulse-width of VCOMP_OUT(t), the phase-shift between V_PWM_H(t) or V_PWM_L #(t) and V_SENSE_NEW′(t) can be estimated. This phase-shift corresponds to the phase-lag of i_{L}(t) with respect to V_{CE}(t). Accordingly, the controller 114 can turn on or off an induction cooking system or control a frequency of the current to the induction heating coil based on a comparison of the conditioned current signal to the pulse-width modulated waveform.

For example, if VCOMP_OUT(t) is fed into a low-pass R-C filter, then a DC voltage can be obtained at the output of the R-C filter with the DC level being directly proportional to the ratio of pulse-width (phase-shift interval) to switching period. Furthermore, this pulse-width represents an interval in which the conditioned current signal (V_SENSE_NEW′(t)) is lower than the pulse-width modulated waveform (V_PWM_H(t) or V_PWM_L #(0), as shown in FIG. 6. It should be noted that the inverse of VCOMP_OUT(t) can be also obtained and used instead of VCOMP_OUT(t). For example, if the inverse of VCOMP_OUT(t) is fed into a low-pass R-C filter, then a DC voltage can be obtained at the output of the R-C filter with the DC level being directly proportional to one minus the ratio of pulse-width (phase-shift interval) to switching period. The inverse of VCOMP_OUT(t) has a pulse-width that represents an interval in which the conditioned current signal (V_SENSE_NEW′(t)) is higher than the pulse-width modulated waveform (V_PWM_H(t) or V_PWM_L #(t)).

PWM signals (V_PWM_H(t) and V_PWM_L(t)) are produced with the controller 114, which may be a microcontroller. As a result, the PWM signals are much less distorted compared to other signals that can be used as a phase shift reference. These other signals include either of collector-to-emitter voltages of inverter switches Q1 and Q2 and either of gate-to-emitter voltages of inverter switches Q1 and Q2.

Furthermore, it is noted that because V_SENSE_NEW′(t) is a scaled function of i_{L}(t), its |dV/dt| is limited by a relatively large inductance of the induction heating coil 110. Therefore, V_SENSE_NEW′(t) can be a clean signal without significant harmonic distortions of high frequencies.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An induction heating system comprising:
an induction heating coil operable to inductively heat a load with a magnetic field;
a variable frequency inverter module supplying an alternating current to the induction heating coil;
a current sensor for detecting a current through the induction heating coil and providing a current signal representative of said current; and
a controller for controlling the frequency of the current to the induction heating coil and to condition the current signal to create a conditioned current signal, the controller further configured to determine a presence of a load on the induction heating coil and control a frequency of the current to the induction heating coil based on a comparison of the conditioned current signal to a pulse-width modulated waveform.

2. The system of claim 1, wherein the current sensor comprises a current transformer in series with the induction heating coil.

3. The system of claim 1, wherein the current sensor comprises a Hall-Effect sensor in electrical communication with the induction heating coil.

4. The system of claim 1, wherein the current sensor comprises a current shunt monitor effectively in parallel with the induction heating coil.

5. The system of claim 1, wherein the controller is further configured to determine a presence of a load on the induction heating coil based on the comparison of the conditioned current signal to a pulse-width modulated waveform.

6. The system of claim 1, wherein the comparison of the conditioned current signal to a pulse-width modulated waveform produces a comparator output, the comparator output being a voltage pulse train with a pulse-width representing an interval in which the conditioned current signal is lower or higher than the pulse-width modulated waveform.

7. The system of claim 6, wherein a phase-shift of an operational current of the induction heating coil and the current signal corresponds to the pulse-width of the voltage pulse train or to a switching period minus the pulse-width of the voltage pulse train.

8. The system of claim 1, wherein the controller is a micro-controller configured to provide the pulse-width modulated waveform to the inverter module for controlling the frequency of the current to the induction heating coil.

9. The system of claim 1, wherein the variable frequency inverter module comprises at least two switching device configured to receive the pulse-width modulated waveform and output current to the induction heating coil.

10. The system of claim 9, wherein the at least two switching devices are Insulated-Gate Bipolar Transistors or Metal-Oxide Semiconductor Field Effect Transistors.

11. An induction heating system comprising:
an induction heating coil operable to inductively heat a load with a magnetic field;
a variable frequency inverter module supplying an alternating current to the induction heating coil;
a current transformer in series with the induction heating coil and providing a current signal representative of a current flowing through the induction heating coil; and
a controller for controlling the frequency of the current to the induction heating coil and to condition the current signal to create a conditioned current signal, the controller further configured to determine a presence of a load on the induction heating coil and control a frequency of the current to the induction heating coil.

12. The system of claim 11, wherein the controller is further configured to determine a size of the load on the induction heating coil based on a comparison of the conditioned current signal to a pulse-width modulated waveform.

13. The system of claim 12, wherein the comparison of the conditioned current signal to a pulse-width modulated waveform produces a comparator output, the comparator output being a voltage pulse train with a pulse-width representing an interval in which the conditioned current signal is lower or higher than the pulse-width modulated waveform.

14. The system of claim 13, wherein a phase-shift of an operational current of the induction heating coil and the current signal corresponds to the pulse-width of the voltage pulse train or to a switching period minus the pulse-width of the voltage pulse train.

15. The system of claim 11, wherein the controller is a micro-controller configured to provide a pulse-width modulated waveform to the inverter module for controlling the frequency of the current to the induction heating coil.

16. The system of claim 11, wherein the variable frequency inverter module comprises at least two switching devices configured to receive a pulse-width modulated waveform and output current to the induction heating coil.

17. The system of claim 16, wherein the at least two switching devices are Insulated-Gate Bipolar Transistors or Metal-Oxide Semiconductor Field Effect Transistors.

18. An induction heating system comprising:
an induction heating coil operable to inductively heat a load with a magnetic field;
a variable frequency inverter module supplying an alternating current to the induction heating coil;
a current shunt monitor effectively in parallel with the induction heating coil and providing a voltage signal representative of a scaled current flowing through the induction heating coil; and
a controller for controlling the frequency of the current to the induction heating coil and to condition the current signal to create a conditioned current signal, the controller further configured to determine a presence of a load on the induction heating coil and control a frequency of the current to the induction heating coil.

19. The system of claim 18, wherein the controller is further configured to determine a size of the load on the induction heating coil based on a comparison of the conditioned current signal to a pulse-width modulated waveform.

20. The system of claim 19, wherein the comparison of the conditioned current signal to a pulse-width modulated waveform produces a comparator output, the comparator output being a voltage pulse train with a pulse-width representing an interval in which the conditioned current signal is lower or higher than the pulse-width modulated waveform.
